(19) United States
(12) Patent Application Publication
(10) Pub. No.: US 2010/0055465 A1
(43) Pub. Date: Mar. 4, 2010

(54) CARBON-CARBON COMPOSITES FOR USE IN THERMAL MANAGEMENT APPLICATIONS

(76) Inventors: Andrew Palmer, Pique, OH (US); Partick D. Lake, Beavercreek, OH (US); David Burton, Waynesville, OH (US); Max Lake, Yellow Springs, OH (US); Carla R. Lake, Beavercreek, OH (US)

Correspondence Address: DINSMORE & SHOHL LLP, FIFTH THIRD CENTER, ONE SOUTH MAIN STREET, SUITE 1300, DAYTON, OH, 45402-2023, US

(21) Appl. No.: 12/550,809

(22) Filed: Aug. 31, 2009

Related U.S. Application Data
(60) Provisional application No. 61/093,076, filed on Aug. 29, 2008.

(51) Int. Cl. B32B 9/00; C09K 3/00; B05D 1/00

(52) U.S. Cl. 428/408; 252/182.32; 427/249.1

(57) ABSTRACT

A method of forming a carbon-carbon composite is provided in which a blend of vapor grown carbon fibers, carbon nanofibers, and optionally, nano-graphene platelets are formed into a preform, densified, and then graphitized. The composite is low in cost to produce and exhibits high thermal conductivity for use in a variety of thermal management applications.

### CROSS-REFERENCE TO RELATED APPLICATIONS

This application claims the benefit of U.S. Provisional Application No. 61/093,076, filed Aug. 29, 2008, entitled HIGHLY GRAPHITIC CARBON-CARBON COMPOSITES FOR THERMAL MANAGEMENT. The entire contents of said application is hereby incorporated by reference.

### BACKGROUND OF THE INVENTION

The present invention relates to the fabrication of a carbon-carbon composite for use in thermal management applications such as electronic packaging, and more particularly, to carbon-carbon composites having high thermal conductivity which are formed from a combination of carbon materials intended to maximize the packing fraction of graphitic reinforcement in the composite.

Thermal management materials used for electronic packaging strongly affect the effectiveness of such packaging in terms of reliability and cost. For example, in electronic systems, packaging materials may serve as electrical conductors or insulators, provide thermal paths, and protect the circuits from environmental factors such as moisture. Electronic packaging materials typically comprise thermally conducting materials such as aluminum, beryllium oxide, and copper-tungsten.

The introduction of smaller electronic devices into the marketplace within recent years has increased the demand for highly thermally conductive materials. For example, increased power and heat flux levels for electronic packages are anticipated for a wide range of products, including single chip modules, high power devices, multichip modules, and high performance computers. Aerospace applications for thermal management materials include space based radar, space operation vehicles, and airborne lasers.

Along with the need for thermal management materials having high thermal conductivity, there is a desire for materials with a low coefficient of thermal expansion to decrease the negative impacts associated with thermal stress. Thermal management materials should also have high mass specific thermal conductivity to correspond with high circuit packaging density, high power, and the miniaturization of the electronics.

High thermal conductivity composites have been fabricated which facilitate heat transfer through the composite. See, for example, commonly assigned U.S. Pat. No. 5,837,081, which teaches the use of vapor grown carbon fibers to fabricate high thermal conductivity composites. A method for producing such vapor grown carbon nanofibers is taught in commonly assigned U.S. Pat. No. 5,024,818, the disclosure of which is hereby incorporated by reference.

However, there is still a need in the art for composite materials based on highly thermally conductive materials for use in thermal management applications which are low in cost to produce.

### SUMMARY OF THE INVENTION

Embodiments of the invention meet that need by providing a highly graphitic carbon/carbon composite formed from a combination of highly graphitic materials which exhibits improved thermal conductivity for use in thermal management applications and which is low in cost to produce.

According to one aspect of the invention, a method of forming a carbon-carbon composite is provided which comprises combining from 0 to about 25 wt % vapor grown carbon fibers; from about 10 to about 100 wt % carbon nanofibers; and from 0 to about 20 wt % nano-graphene platelets with a solvent to form a blend; forming the blend into a preform; and densifying the preform to form the composite. The solvent is preferably selected from isopropyl alcohol, furfuryl alcohol, and methyl ethyl ketone.

In another embodiment, the blend comprises from about 5 to about 15 wt % vapor grown carbon fibers, from about 10 to about 90 wt % carbon nanofibers; and from about 0 to about 15 wt % nano-graphene platelets.

The vapor grown carbon fibers preferably have a bulk density ranging from about 1.8 to about 2.15 g/cm³. The carbon nanofibers preferably have a bulk density ranging from about 0.001 to about 0.26 g/cm³. The blend may comprise carbon nanofibers having differing densities. For example, in one embodiment, the blend comprises about 85 wt % carbon nanofibers having a bulk density of about 0.033 g/cm³ and about 15 wt % carbon nanofibers having a bulk density of about 0.072 g/cm³.

In another embodiment, the blend comprises about 65 wt % carbon nanofibers having a density of about 0.033 g/cm³, about 15 wt % carbon nanofibers having a density of about 0.072 g/cm³, about 10 wt % vapor grown carbon fibers, and about 10 wt % nano graphene platelets. In yet another embodiment, the blend comprises about 15 wt % carbon nanofibers having a density of about 0.032 g/cm³, about 15 wt % carbon nanofibers having a density of about 0.080 g/cm³, about 50 wt % carbon nanofibers having a density of about 0.160 g/cm³, about 10 wt % vapor grown carbon fibers, and about 10 wt % nano-graphene platelets.

In one embodiment, the preform is densified by infiltration of the preform with a wetting monomer selected from naphthalene, anthracene, methylnaphthalene, ethylnaphthalene, tetrahydronaphthalene, pyrene, pentacene, phenathrene, methylphenanthrene, and ethylphenanthrene, followed by in-situ polymerization.

In an alternative embodiment, the preform is densified by infiltration of the preform with molten pitch.

The method preferably further includes graphitizing the composite by heating the densified composite to a temperature of about 3000° C. The resulting carbon-carbon composite formed by the method has a conductivity of at least 500 to 650 W/m-K, and preferably, at least 800 w/m-K.

In another embodiment of the invention, the method further includes growing vapor grown carbon fibers on the preform prior to densification by coating the preform with an iron-based catalyst solution; and exposing the catalyst-doped preform to a gas mixture. A preferred gas mixture comprises methane and hydrogen.

Accordingly, it is a feature of embodiments of the invention to provide a method of forming a carbon-carbon composite which is formed from a combination of carbon materials which exhibits increased thermal conductivity for use in thermal management applications. Other features and advantages of the invention will be apparent from the following description and the appended claims.

### DETAILED DESCRIPTION

We have found that the use of a combination of highly graphitic materials such as carbon nanofibers, vapor grown carbon fibers, and other graphitic additives such as nano-graphene platelets in a carbon-carbon composite provides a thermal management material which performs to the specifications of the current electronics industry while being low in cost to produce. While previous methods have focused on fabricating porous preforms of continuous fibers followed by multiple cycles of densification, carbonization, and graphitization to yield a fully dense composite with high thermal conductivity, with the method of the invention, the need for such multiple cycling is reduced significantly by increasing the initial preform density by the use of a combination of carbon materials, which results in a significant reduction in costs.

In addition, the formed composites can be used as a substrate material to support vapor grown carbon fiber growth. The resulting fibers and substrate materials can be directly incorporated into a carbon composite, which significantly reduces labor and cost.

Preferred carbon nanofibers for use in the present invention are vapor grown carbon nanofibers having a graphitic nature. Suitable nanofibers include Pyrograf® III, commercially available from Applied Sciences, Inc. and Pyrograf Products, Inc. The preferred carbon nanofibers are essentially comprised of a graphitic hollow tube, referred to as the catalytic phase of the carbon nanofiber, and having essentially no turbostratic or disordered carbon on the surface of the nanofiber. This type of nanofiber is preferred as it is highly electrically conductive and has a high surface area and surface energy. The carbon nanofibers preferably have a length of from about 200 micrometers or less, and more preferably, between about 50 to 100 micrometers. The carbon nanofibers preferably have a diameter of from about 80 to about 200 nm.

Preferred vapor grown carbon fibers (VGCF) for use in the composite are commercially available under the designation Pyrograf® I. The fibers may be heat treated prior to composite formation, but a heat treatment is not required. In some instances, it is a cost advantage to heat-treat after the fibers are consolidated to the final density and shape.

Suitable nano-graphene platelets for use in the present invention are commercially available from multiple domestic and international suppliers, including XG Sciences, Angstron Materials LLC and Vorbeck Materials Corp.

In one embodiment of the method, carbon nanofibers (CNF) are combined with vapor grown carbon fibers (VGCF). Different bulk densities of the carbon nanofibers ranging from 0.001 g/cm³ to 0.26 g/cm³ are preferably used to ensure superior transport properties and flexibility in the final product. Preferably, a blend of a selected percentage of VGCF is used in combination with carbon nanofibers having varying densities in the range of 0.03 g/cc to 0.12 g/cc. This blend enables a loading of graphitic fibers which is optimized for high weight without adversely affecting the aspect ratio of either the VGCF or CNF. It should be appreciated that the ratio of these graphitic components may be modified to alter the mechanical strength and thermal conductivity of the finished composite article.

In the method of forming the preform, the vapor grown carbon fibers are preferably sonicated in a solvent such as isopropyl alcohol followed by the addition of carbon nanofibers and optional nano-graphene platelets. Other suitable solvents include furfuryl alcohol, methyl ether ketone, and other graphitizable binders. The combined fibers are then filtered on a membrane filter, dried, and then recovered to form a preform having a preferred sheet thickness of from 50 to 1000 microns, which may be varied by adjusting the volume of the suspension.

In one embodiment, densification of the preform may then be performed using the method of in-situ polymerization of wetting monomers. This technique is a rapid, low-cost method which imparts a highly graphitizable matrix, and is capable of uniform densification of thick parts. The preform is infiltrated/impregnated with low viscosity, low molecular weight monomers such as naphthalene. Other suitable monomers include naphthalene, anthracene, methylnaphthalene, ethylnaphthalene, tetrahydronaphthalene, pyrene, pentacene, phenanthrene, methylphenanthrene, and ethylphenanthrene. This densification technique is described in U.S. Pat. Nos. 6,756,112 and 6,706,401, the disclosures of which are incorporated herein by reference and includes fabrication of a rigidized preform consisting of reinforcing carbon fibers, followed by infiltration of low viscosity monomers which readily wet the reinforcing fibers and fill the void content of the preform, polymerization of the monomers to yield a high molecular weight matrix precursor, and finally, heat treatment to fully graphitize the composite article.

The initiation technique for the polymerization may include any of those techniques used to start and sustain single-phase polymerization including, but not limited to, changing temperature and/or pressure, adding catalysts or reaction initiators to the monomer prior to and/or after impregnation of the preform, depositing catalysts or reaction initiators within the preform prior to monomer impregnation, and exposing the preform after impregnation to any of the forms of radiation, energetic atomic particle beams, or electromagnetic fields which initiate and sustain polymerization.

In an alternative embodiment, densification of the preform may be achieved by infiltrating the preform with a matrix carbon derived from phenolic resin or pitch which is then carbonized by heat treatment to 900° C. in an inert gas. The resin is incorporated using a liquid infiltration technique in which the preform is densified by infusing molten pitch from coal tar or petroleum sources into the fiber preform under heat and pressure. This process is followed by pyrolysis and subsequent re-impregnations until the pores between the fibers are filled to the point of sealing as known in the art. See, for example, U.S. Pat. Nos. 4,490,201 and 4,396,663, the disclosures of which are incorporated herein by reference.

Regardless of the densification method used, graphitization of the densified composite is then performed in a flowing inert gas such as argon at a temperature of 3000° C. Carbon-carbon composites produced using this method exhibit a thermal conductivity of about 800 w/m-K/g.

It should also be appreciated that there are instances in which it is desirable to increase the percentage of graphite in the composite, which can be done by growing vapor grown carbon fibers on the preform prior to the densification step. The preform may be coated with an iron-based organometallic catalyst solution which is diluted in water. Examples of suitable iron particles for use in the solution include ferrosulfate or ferrofluid. The catalyst-coated preform is then exposed to a gas mixture. Preferably, the coated preform is exposed to a gas mixture of 10% methane and 90% hydrogen for a period of about 10 minutes, followed by exposure to a gas mixture of 50% methane and 50% hydrogen for about 120 minutes, while maintaining a temperature of between about 950° C. and 1100° C.

In order that the invention may be more readily understood, reference is made to the following examples which are intended to illustrate the invention, but not limit the scope thereof.

### EXAMPLE 1

Commercially available carbon nanofibers (CNF) under the trade name Pyrograf® III-PR 25-PS were used in combination with macroscopic vapor grown carbon fibers (VGCF) available under the trade name Pyrograf® I. The carbon nanofibers were milled to reduce the length of the fibers prior to combination with VGCF. Ball milling equipment was used to generate CNF of different average lengths ranging from 5 micrometers to 200 micrometers. The bulk density value of the milled CNF was used to differentiate average lengths of the milled CNF, with higher bulk densities having a lower average nanofiber length.

A blend of different densities of the CNF was used to optimize the loading of the graphitic particles in the preform to ensure superior transport properties and flexibility in the final product. The CNF were milled to yield densities ranging from about 2 lbs./ft³, 5 lbs./ft³, and 10 lbs./ft³ with corresponding average length of the CNF of about 100 micrometers, 20 micrometers, and 5 micrometers, respectively. In one instance, a blend of carbon nanofibers comprised of 15 wt % CNF having a density of

2 lbs./ft³, 15 wt % of CNF having a density of 5 lbs./ft³, and 50 wt % of CNF having a density of 10 lbs./ft³ were blended with 10 wt % macroscopic VGCF and 10 wt % of nano-graphene platelets to produce a high density preform. The vapor grown carbon fibers were sonicated in isopropyl alcohol (250 mL) for 10 minutes with a sonic probe (Misonix 3000). Carbon nanofibers were then added to the suspension, and after sonicating for 5 minutes, the suspension was filtered on a 7″×7″ filtering device combined with a polypropylene membrane filter having a pore size of 0.45 microns (Sterlitech). The sheet was then dried under a heat gun and recovered by peeling off the filter membrane.

Composite densification was performed using the method of in situ polymerization of wetting monomers. The rigidized preforms were then impregnated with naphthalene.

Following impregnation, polymerization was initiated to yield a high molecular weight matrix precursor, which was then pyrolyzed. Initial testing of one CNF/carbon composite yielded a thermal conductivity contribution from the matrix of approximately 800 w/m-K/g, comparable to that obtained from one-dimensional VGCF preforms alone. Two densification cycles, each followed by a graphitization step, were used to generate composite densities of approximately 1.6 g/cc. Graphitization was performed in a flowing inert gas to a temperature of 3000° C. at GrafTech International, Ltd., Parma, Ohio.

### Results

Thermal conductivity measurements of carbon-carbon composites made using Pyrograf®-I VGCF at different stages of densification are shown below in Table 1. As expected, the thermal conductivity increases with composite density. Specific heat measurements were consistently measured at 720 J/kg·° C.

TABLE 1

| Composite material | Density (g/cc) | Thermal Conductivity (W/m-K) |
|---|---|---|
| Pyrograf-I VGCF | 0.6 | 400 |
| Pyrograf-I VGCF | 1.6 | 580 |
| Pyrograf-I VGCF | 1.9 | 910 |

These conductivity values exceed the highest values measured for either pitch or CVI infiltrations of comparable density (1.55 to 1.6 g/cc).

Table 2 lists preliminary thermal conductivity results for a composite fabricated using carbon nanofibers and nano-graphene platelets (NGP) with a polyimide resin for a binder using resin film infusion techniques. The results indicate that using this method of fabricating carbon-carbon composites can result in a high thermal conductivity composite using discontinuous, low cost materials.

TABLE 2

| Composite material | Density (g/cc) | Thermal Conductivity (W/m-K) |
|---|---|---|
| Carbon nanofibers/ | 0.7 | 500-650 |
| nano-graphene | | |
| platelets | | |

### EXAMPLE 2

Commercially available carbon nanofibers (CNF) under the trade name Pyrograf® III-PR 25-PS were used in combination with macroscopic vapor grown carbon fibers (VGCF) available under the trade name Pyrograf® I. Different densities of the CNF were used to ensure superior transport properties and flexibility in the final product.

The vapor grown carbon fibers were sonicated in isopropyl alcohol (25 mL) for 10 minutes with a sonic probe (Misonix 3000). Carbon nanofibers were then added to the suspension, and after sonicating for 5 minutes, the suspension was filtered on a 7″×7″ filtering device combined with a polypropylene membrane filter having a pore size of 0.45 microns (Sterlitech). The sheet was then dried under a heat gun and recovered by peeling off the filter membrane.

A preform was then prepared as described in Example 1. The preform was then coated with an iron based catalyst solution and was loaded into a tube furnace. The catalyst doped preform was then exposed to methane and hydrogen at 1100° C. for 4 hours, whereupon macroscopic vapor grown carbon fibers were grown in the interstices of the porous preform and on the surface of the preform. The vapor grown carbon fibers were oriented preferentially in the direction of gas flow and with respect to gravity.

Having described the invention in detail and by reference to preferred embodiments thereof, it will be apparent that modifications and variations are possible without departing from the scope of the invention.

What is claimed is:

1. A method of forming a carbon-carbon composite comprising:
combining from 0 to about 25 wt % vapor grown carbon fibers;
from about 10 to about 100 wt % carbon nanofibers; and from 0 to about 20 wt % nano-graphene platelets with a solvent to form a blend;
forming the blend into a preform; and
densifying said preform.

2. The method of claim 1 wherein said blend comprises from about 5 to about 15 wt % vapor grown carbon fibers, from about 10 to about 90% carbon nanofibers; and
from 0 to about 15 wt % nano-graphene platelets.

3. The method of claim 1 wherein said solvent is selected from isopropyl alcohol, furfuryl alcohol, and methyl ethyl ketone.

4. The method of claim 1 wherein densifying said preform comprises infiltration of said preform with a wetting monomer selected from naphthalene, anthracene, methylnaphthalene, ethylnaphthalene, tetrahydronaphthalene, pyrene, pentacene, phenanthrene, methylphenanthrene, and ethylphenanthrene, followed by in-situ polymerization.

5. The method of claim 1 wherein densifying said preform comprises infiltrating said preform with molten pitch.

6. The method of claim 1 wherein said vapor grown carbon fibers have a bulk density ranging from about 1.8 to 2.15 g/cm³.

7. The method of claim 1 wherein said carbon nanofibers have a bulk density ranging from about 0.001 to 0.26 g/cm³.

8. The method of claim 1 wherein said blend comprises carbon nanofibers having differing densities.

9. The method of claim 1 wherein said blend comprises about 85 wt % carbon nanofibers having a density of about 0.033 g/cm³, and about 15 wt % carbon nanofibers having a density of about 0.072 g/cm³.

10. The method of claim 1 wherein said blend comprises about 65 wt % carbon nanofibers having a density of about 0.033 g/cm³, and about 15 wt % carbon nanofibers having a density of about 0.072 g/cm³, about 10 wt % vapor grown carbon fibers, and about 10 wt % nano-graphene platelets.

11. The method of claim 1 wherein said blend comprises about 10 wt % vapor grown carbon fibers.

12. The method of claim 1 wherein said blend comprises about 10 wt % nano-graphene platelets.

13. The method of claim 1 including graphitizing said composite by heating said densified composite to a temperature of about 3000° C.

14. A carbon-carbon composite formed by the method of claim 1 having a conductivity of from about 500 to 650 W/m-K.

15. A carbon-carbon composite formed by the method of claim 1 having a conductivity of about 800 w/m-K.

16. The method of claim 1 further including growing vapor grown carbon fibers on said preform prior to densifying said preform by coating said preform with an iron-based catalyst solution and exposing the catalyst-doped preform to a gas mixture.
